(19) United States
(12) Patent Application Publication
(10) Pub. No.: US 2025/0105387 A1
(43) Pub. Date: Mar. 27, 2025

(54) ELECTRICITY STORAGE DEVICE AND METHOD OF MANUFACTURING RECOVERED NEGATIVE ELECTRODE CURRENT COLLECTOR

(71) Applicant: Prime Planet Energy & Solutions, Inc., Tokyo (JP)

(72) Inventor: Shuhei TAKESHITA, Nagakute-shi (JP)

(21) Appl. No.: 18/882,750

(22) Filed: Sep. 12, 2024

(30) Foreign Application Priority Data
Sep. 25, 2023 (JP) 2023-160120

(51) Int. Cl. H01M 10/54; H01G 11/48; H01M 4/02; H01M 4/62

(52) U.S. Cl. CPC H01M 10/54; H01M 4/622; H01G 11/48; H01M 2004/027

(57) ABSTRACT

Provided is a technology enabling a negative electrode active material to be more easily separated from a negative electrode current collector. An electricity storage device includes a negative electrode. A negative electrode active material layer includes a first negative electrode active material layer and a second negative electrode active material layer. The first negative electrode active material layer contains a negative electrode active material, a binder made of a resin A, and a resin B. The second negative electrode active material layer contains the negative electrode active material and the binder. The content of the resin B in the second negative electrode active material layer is smaller than that in the first negative electrode active material layer. The resin B has water solubility and thermoplasticity. The first negative electrode active material layer is provided between the second negative electrode active material layer and a negative electrode current collector.

### CROSS REFERENCE TO RELATED APPLICATION

The present application claims the priority based on Japanese Patent Application No. 2023-160120 filed on Sep. 25, 2023, the entire contents of which are incorporated in the present specification by reference.

### BACKGROUND OF THE DISCLOSURE

### 1. Technical Field

The present disclosure relates to an electricity storage device and a method of manufacturing a recovered negative electrode current collector.

### 2. Background

Japanese Patent Application Publication No. 2017-98155 discloses a method of manufacturing a non-aqueous electrolyte secondary battery. This manufacturing method includes the steps of: mixing polyethylene oxide (PEO) having a number average molecular weight of 2 million or more, carboxymethylcellulose (CMC), and water to prepare an aqueous solution of PEO and CMC; adding a negative electrode active material and a binding agent to the aqueous solution and kneading them to obtain a negative electrode paste; applying the negative electrode paste to a negative electrode current collector and drying them to obtain a negative electrode. This publication states that the method with such an arrangement can manufacture a non-aqueous electrolyte secondary battery with better initial resistance and suppressed increase in battery resistance when repeatedly charged and discharged at a high rate.

Japanese Patent Application Publication No. H9-45328 discloses a lithium secondary battery including a spiral electrode body and a non-aqueous electrolyte, the electrode body being provided by spirally winding a negative electrode and a positive electrode with a separator interposed between them. The negative electrode has an active material layer formed on a metal foil or film and containing a powder of carbon particles and a binding agent. The non-aqueous electrolyte contains a halogen-containing lithium salt as a solute. The carbon particles have a polyethylene oxide film on their surfaces. This publication states that the polyethylene oxide film on the surfaces of the carbon particles can prevent the carbon particles in a charging state from coming into contact with a halogenated hydroxide acid generated in a battery can, thus reducing the probability of self-discharge occurring, even after the battery has been stored for a long time.

Japanese Patent Application Publication No. 2014-127417 discloses a method of reusing a negative electrode active material layer of a lithium ion battery. This method includes steps (1) to (3). In step (1), a negative electrode having a current collector and a negative electrode active material layer containing a non-aqueous binder is immersed in an aqueous solution at a temperature higher than 50° C. In step (2), the negative electrode active material layer that has been peeled off is collected. In step (3), the recovered negative electrode active material layer is affixed onto a current collector. This publication states that the negative electrode active material layer can be recovered with almost no change in its composition because the negative electrode active material layer can be peeled off from the current collector using an aqueous solution. The publication also states that after drying the peeled negative electrode active material layer, a solvent for viscosity adjustment is added thereto and stirred with a homogenizer to form a slurry, and the slurry can be applied to the negative electrode current collector, which enables the reuse of the negative electrode.

Japanese Patent Application Publication No. 2006-228509 discloses a method of reusing a negative electrode active material for a non-aqueous electrolyte secondary battery. This method includes the steps of: removing a negative electrode plate from a non-aqueous electrolyte secondary battery; washing the negative electrode plate with a liquid containing water, separating the washed negative electrode plate into a current collector substrate and a negative electrode composite material containing a negative electrode active material and a binding agent; and mixing the negative electrode composite material in a solvent that can dissolve or disperse the binding agent to fabricate a negative electrode paste, and then applying the paste onto a negative electrode current collector. This publication states that such a method enables the reuse of a used negative electrode active material as the negative electrode active material for non-aqueous electrolyte secondary batteries.

### SUMMARY

In recent years, with the widespread use of electricity storage devices, there has been a growing interest in reusing these electricity storage devices, which requires further development of technologies for reusing them. For this reason, the inventors have decided to study a configuration of an electricity storage device that is easy to reuse when used. The inventors have aimed to easily separate a negative electrode active material layer from a negative electrode current collector.

An electricity storage device disclosed herein includes a negative electrode having a sheet-shaped negative electrode current collector and a negative electrode active material layer provided on the negative electrode current collector. The negative electrode active material layer includes a first negative electrode active material layer and a second negative electrode active material layer. The first negative electrode active material layer contains a negative electrode active material, a binder made of a resin A, and a resin B. The second negative electrode active material layer contains the negative electrode active material and the binder. The content of the resin B in the second negative electrode active material layer is smaller than the content of the resin B in the first negative electrode active material layer. The resin B here is a resin having water solubility and thermoplasticity. The first negative electrode active material layer is provided between the second negative electrode active material layer and the negative electrode current collector. With such a configuration, the negative electrode active material layer can be more easily separated from the negative electrode current collector.

### BRIEF DESCRIPTION OF THE DRAWINGS

FIG. 1 is a schematic cross-sectional view of an electricity storage device 100.

FIG. 2 is a schematic diagram of an electrode body 20.

FIG. 3 is a schematic cross-sectional view of a negative electrode 60.

FIG. 4 is a schematic cross-sectional view of a first negative electrode active material layer 641.

FIG. 5 shows an SEM observation image of Example 1.

FIG. 6 shows a binarized image of Example 1.

FIG. 7 shows an SEM observation image of Example 2.

FIG. 8 shows a binarized image of Example 2.

FIG. 9 shows an SEM observation image of Comparative Example 1.

FIG. 10 shows a binarized image of Comparative Example 1.

### DESCRIPTION OF THE EMBODIMENTS

Hereinafter, one embodiment of the technology disclosed herein will be described. The embodiment described herein is not intended to particularly limit the technology disclosed herein. The technology disclosed herein is not limited to the embodiment described herein, unless otherwise noted. The drawings are schematic and do not necessarily reflect actual products. Members and parts that have the same actions are appropriately denoted by the same symbols as appropriate, and a duplicate description thereof is omitted. The notation “A to B” indicating a numerical value range means “A or more and B or less”, unless otherwise noted, and also includes the meaning of “above A and below B”.

In the present specification, the term “electricity storage device” refers to a device where charging and discharging occur due to transfer of charge carriers between a pair of electrodes (positive and negative electrodes) via an electrolyte. Such electricity storage devices include secondary batteries such as lithium ion secondary batteries, nickel-metal hydride batteries, and nickel-cadmium batteries; capacitors such as lithium-ion capacitors and electric double layer capacitors; and the like. In the following, an embodiment related to a lithium ion secondary battery will be described as an example of the electricity storage device.

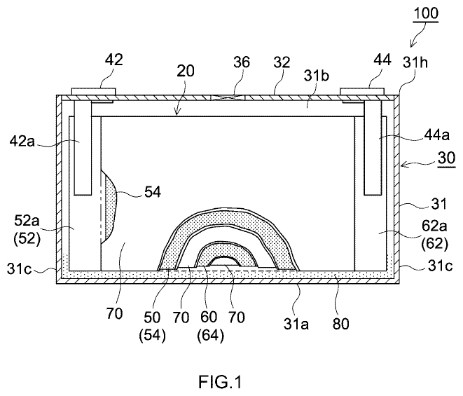

FIG. 1 is a schematic cross-sectional view of an electricity storage device 100. FIG. 1 is a schematic cross-sectional view taken along a first side surface 31b of the electricity storage device 100. As illustrated in FIG. 1, the electricity storage device 100 has an electrode body 20, a case 30, and a non-aqueous electrolyte 80.

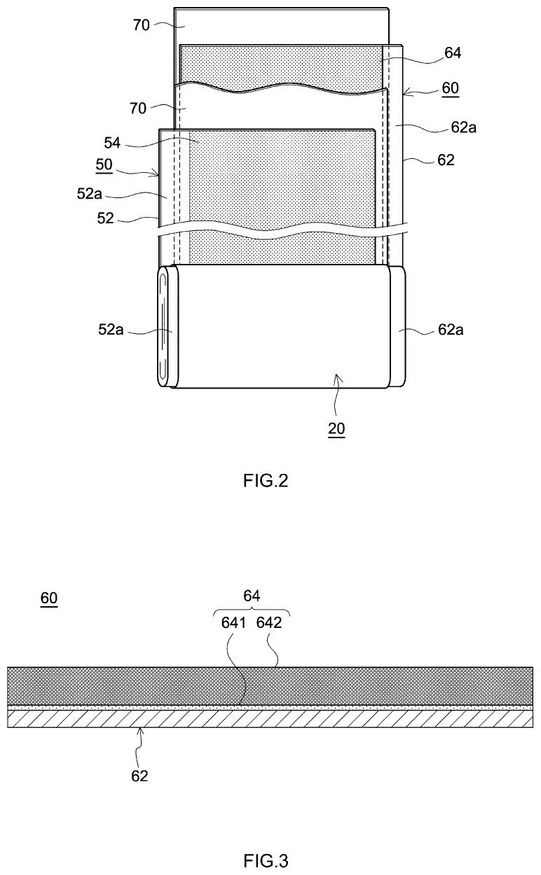

FIG. 2 is a schematic diagram of the electrode body 20. As shown in FIGS. 1 and 2, the electrode body 20 is a wound electrode body in which a long sheet-shaped positive electrode 50 and a long sheet-shaped negative electrode 60 are overlapped each other with a long sheet-shaped separator 70 interposed between them, and these electrodes are wound in a sheet longitudinal direction (hereinafter also simply referred to as a “longitudinal direction”). In the electrode body 20, an exposed region 52a of the positive electrode 50 and an exposed region 62a of the negative electrode 60 extend outward from both respective ends in a transverse direction perpendicular to the longitudinal direction.

As shown in FIGS. 1 and 2, the positive electrode 50 has a long sheet-shaped positive electrode current collector 52 and a positive electrode active material layer 54. The positive electrode current collector 52 is, for example, an aluminum foil. In this embodiment, the positive electrode current collector 52 has a region where the positive electrode active material layer 54 is provided, as well as the exposed region 52a where a portion of the surface of the positive electrode current collector 52 is exposed with no positive electrode active material layer 54 provided. The positive electrode active material layer 54 is provided in the form of strip, for example, on one or both surfaces (here, both surfaces) of the positive electrode current collector 52 along the longitudinal direction. The positive electrode active material layer 54 is not provided at an end of the positive electrode current collector 52 in the transverse direction (left end in the figure). The exposed region 52a here is a strip-shaped region at the end of the positive electrode current collector 52 in the transverse direction (left end in the figure). As shown in FIG. 1, a current collector plate 42a is attached to the exposed region 52a.

The positive electrode active material layer 54 contains, for example, a positive electrode active material. Examples of the positive electrode active material include lithium transition metal oxides such as lithium nickel cobalt manganese composite oxides (NCM) (e.g., LiNi_{1/3}CO_{1/3}Mn_{1/3}O₂), LiNiO₂, LiCoO₂, LiFeO₂, LiMn₂O₄, and LiNi_{0.5}Mn_{1.5}O₄; lithium transition metal phosphate compounds such as LiFePO₄; and the like. In addition to the positive electrode active material, the positive electrode active material layer 54 may contain conductive materials, binders, and the like. Examples of the conductive material include carbon black such as acetylene black (AB); and other carbon materials such as graphite. Examples of the binder include polyvinylidene fluoride (PVDF) and the like.

FIG. 3 is a schematic cross-sectional view of the negative electrode 60. Specifically, FIG. 3 shows a partially enlarged view of a schematic cross-sectional structure of a negative electrode current collector 62 and a negative electrode active material layer 64 in the negative electrode 60. As shown in FIGS. 1 to 3, the negative electrode 60 has the long sheet-shaped negative electrode current collector 62 and the negative electrode active material layer 64. The negative electrode current collector 62 is, for example, a copper foil. In this embodiment, the negative electrode current collector 62 has a region where the negative electrode active material layer 64 is provided, as well as the exposed region 62a where a portion of the surface of the negative electrode active material layer 64 is exposed with no negative electrode active material layer 64 provided. The negative electrode active material layer 64 is provided in the form of strip, for example, on one or both surfaces (here, both surfaces) of the negative electrode current collector 62 along the longitudinal direction. The negative electrode active material layer 64 is not provided at an end of the negative electrode current collector 62 (right end in the figure) in the transverse direction perpendicular to the longitudinal direction. The exposed region 62a here is a strip-shaped region at the end of the negative electrode current collector 62 (right end in the figure) in the transverse direction. As shown in FIG. 1, a current collector plate 44a is attached to the exposed region 62a.

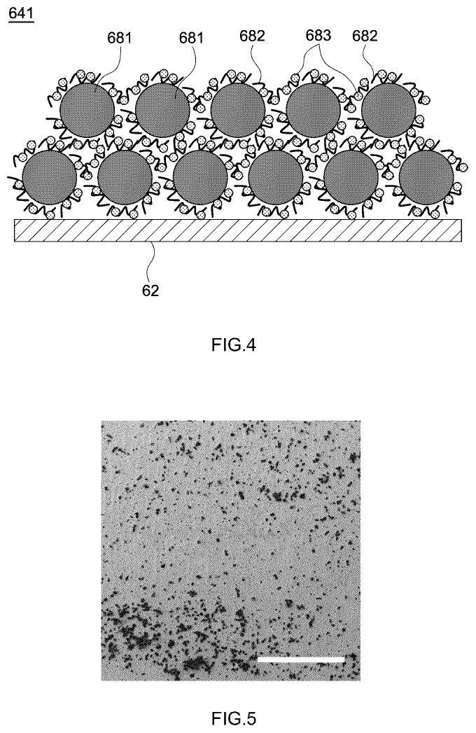

As shown in FIG. 3, the negative electrode active material layer 64 has a first negative electrode active material layer 641 and a second negative electrode active material layer 642. The first negative electrode active material layer 641 here is provided between the negative electrode current collector 62 and the second negative electrode active material layer 642. FIG. 4 is a schematic cross-sectional view of the first negative electrode active material layer 641. Specifically, FIG. 4 shows a partially enlarged view of a schematic cross-sectional structure of the vicinity of the negative electrode current collector 62 in the first negative electrode active material layer 641. As shown in FIG. 4, the first negative electrode active material layer 641 contains a negative electrode active material 681, a binder 682, and a resin B 683.

The negative electrode active material 681 is desirably a carbon material, such as graphite, hard carbon, or soft carbon, but it may be silicon (Si). The binder 682 here is composed of a resin A. The resin A is desirably resin that constitutes a binder used in the negative electrode active material layer of an electricity storage device for this kind of application. The resin A is desirably a water-soluble binder, and for example, desirably styrene butadiene rubber (SBR). By using SBR as the binder 682 (resin A), the joining between the negative electrode current collector 62 and the first negative electrode active material layer 641 can be brought into a better condition, in turn, making the current collection efficiency in the negative electrode 60 adequate. SBR can form an emulsion solution with water. Thus, for example, water can be used when processing the negative electrode 60, in turn, reducing environmental impacts.

The resin B 683 is, for example, a different resin from the resin A 682. The resin B 683 here is a resin having water solubility and thermoplasticity. In the present specification, the phrase “resin having thermoplasticity” refers to a resin having properties of reversibly softening or melting at a temperature of its glass transition point or higher, enabling its plastic deformation, and reversibly hardening at a temperature below the glass transition point. By including the resin B 683, which has water solubility and thermoplasticity, in the first negative electrode active material layer 641, the resin B 683 softens or melts, for example, when the negative electrode 60 is processed with water at a predetermined temperature, reducing the adhesiveness between the first negative electrode active material layer 641 and the negative electrode current collector 62. Thus, the first negative electrode active material layer 641 can be easily separated from the negative electrode current collector 62.

As the resin B 683, for example, a resin having a softening point corresponding to the temperature of the water used to process the negative electrode 60 may be preferably used. The softening point of the resin B 683 is generally 120° C. or lower, for example, 100° C. or lower, preferably 90° C. or lower, more preferably 85° C. or lower, even more preferably 80° C. or lower, and particularly preferably 75° C. or lower. By using a resin having a lower softening point as the resin B 683, the negative electrode current collector 62 and the negative electrode active material layer 64 can be separated from each other with less energy, which can, in turn, contribute to reducing environmental impacts. The softening point of the resin B 683 is, for example, 50° C. or higher, preferably 55° C. or higher, and more preferably 60° C. or higher. By using a resin with a higher softening point as the resin B 683, the negative electrode 60 can be processed at a temperature that is favorable for separating the negative electrode current collector 62 and the negative electrode active material layer 64, in turn enhancing the separation efficiency between the negative electrode current collector 62 and the negative electrode active material layer 64.

In the present specification, the term “softening point” regarding a resin is the temperature at which the resin begins to deform as its temperature is increased. For example, a value obtained using a differential scanning chalorimetry (DSC) may be adopted as the softening point of the resin. Alternatively, a nominal value used by a manufacturer or the like may be adopted.

The weight average molecular weight of the resin B 683 is desirably determined in consideration of a joining strength of the first negative electrode active material layer 641 to the negative electrode current collector 62. The weight average molecular weight of the resin B 683 is generally 30,000 or more, for example, 50,000 or more, preferably 100,000 or more, more preferably 500,000 or more, even more preferably 1 million or more, and particularly preferably 3 million or more. The larger the weight average molecular weight of the resin B 683, the higher the joining strength between the negative electrode current collector 62 and the first negative electrode active material layer 641 can be, thus enabling the negative electrode active material layer 64 to be stably retained on the negative electrode current collector 62. Thus, the current collection efficiency in the negative electrode 60 can be enhanced. The weight average molecular weight of the resin B 683 is generally 30 million or less, for example, 25 million or less, preferably 20 million or less, more preferably 15 million or less, and even more preferably 10 million or less. The smaller the weight average molecular weight of the resin B 683, the more the separation efficiency of the first negative electrode active material layer 641 from the negative electrode current collector 62 can be enhanced, in turn enabling the recovery of the negative electrode current collector 62 with higher purity. As the weight average molecular weight of the resin B 683, for example, a value obtained using a gel permeation chromatography (GPC) can be adopted. Alternatively, a nominal value used by a manufacturer or the like may be adopted.

The kind of the resin B 683 is not particularly limited as long as it has water solubility and thermoplasticity and can achieve the effects of the technology disclosed herein. Examples of the resins B 683 include polyethylene glycol (PEG), polyethylene oxide (PEO), polyvinyl alcohol (PVA), polyvinyl acetate (PVAc), water-soluble acrylic resin (e.g., sodium polyacrylate), and the like. Among these, polyethylene oxide (PEO) can be preferably used from the viewpoint of more appropriately achieving the effects of the technology disclosed herein.

The proportion of the resin B 683 in the first negative electrode active material layer 641 is generally 10 mass % or less, for example, 5 mass % or less, preferably 3 mass % or less, and more preferably 2 mass % or less, relative to the total amount of the first negative electrode active material layer 641 from the viewpoint of appropriately achieving the effects of the technology disclosed herein. From the same viewpoint, the proportion of the resin B 683 in the first negative electrode active material layer 641 is generally 0.1 mass % or more, for example 0.3 mass % or more, preferably 0.5 mass % or more, and more preferably 0.7 mass % or more, relative to the total amount of the first negative electrode active material layer 641.

From the viewpoint of appropriately achieving the effects of the technology disclosed herein, the ratio (mass ratio) of the resin A 682 to the resin B 683 (resin A: resin B) in the first negative electrode active material layer 641 is preferably 1:3 to 3:1, and more preferably 1:2 to 2:1, and it is set even more preferably at about 1:1.

The second negative electrode active material layer 642 here is a layer that contains the negative electrode active material, and the binder. The content of the resin B is smaller than that of the resin B 683 in the first negative electrode active material layer 641. The negative electrode active material used here is the same as the negative electrode active material 681 contained in the first negative electrode active material layer 641. The binder here is the resin A, which is desirably the same as the resin A 682 contained in the first negative electrode active material layer 641.

The second negative electrode active material layer 642 is provided on the first negative electrode active material layer 641 as illustrated in FIG. 3. By providing the first negative electrode active material layer 641 and the second negative electrode active material layer 642, which have mutually different compositions, in the negative electrode 60, the effects of the technology disclosed herein can be achieved, while appropriately enabling the charging and discharging of the electricity storage device 100.

The content of the resin B in the second negative electrode active material layer 642 is, for example, ½ or less, preferably ⅓ or less, more preferably ¼ or less, and even more preferably 1/10 or less of the content of the resin B in the first negative electrode active material layer 641. The smaller the content of the resin B in the second negative electrode active material layer 642, the more the charge-discharge efficiency in the electricity storage device 100 can be enhanced. Therefore, it is preferred that the second negative electrode active material layer 642 is free of the resin B.

The proportion of the binder in the second negative electrode active material layer 642 is desirably, for example, between 0.3 mass % and 10 mass %, and preferably between 0.5 mass % and 5 mass %, taking into consideration that the binder is appropriately retained in the first negative electrode active material layer 641 and that the electricity storage device 100 is appropriately charged and discharged.

The compositions of the first and second negative electrode active material layers 641 and 642 are as described above, but they may contain other additives (e.g., dispersants, surfactants, thickeners, etc.) as needed as long as the effects of the technology disclosed herein can be achieved. The negative electrode active material, the resin A, and the resin B described above are excluded from the other additives.

A fabrication method (manufacturing method) for the negative electrode 60 includes, for example, forming the first negative electrode active material layer 641 and forming the second negative electrode active material layer 642. In forming the first negative electrode active material layer 641, for example, the first negative electrode active material layer 641 is formed on the surface of the negative electrode current collector 62. In this embodiment, the formation of the first negative electrode active material layer 641 includes a preparation step, a solid- kneading step, a dilution step, a mixing step, an applying step, a drying step, and a pressing step.

The preparation step is, for example, a step of preparing the material for the first negative electrode active material layer 641. Here, the negative electrode active material, the resin A as the binder, and the resin B are prepared. The solid-kneading step is, for example, a step of solid-kneading the negative electrode active material with the resin B. First, predetermined amounts of the negative electrode active material and the resin B are put into a mixer (e.g., planetary mixer, etc.) to obtain a mixed powder. Then, water is added to the mixed powder until it becomes clay-like. Then, the mixed powder to which water has been added is kneaded. The solid content in the solid-kneading step is changed as appropriate depending on the kind, combination, etc., of materials used, but desirably it is generally 60% or more (e.g., 60% to 70%). The solid-kneading is desirably performed, for example, until particles that have increased in size beyond a predetermined level (so-called lumps) are eliminated from the kneaded material, bringing the kneaded material into a uniform condition. As described above, in the solid-kneading step, the negative electrode active material and the resin B are kneaded at a high solid content and in a clay-like state. This allows the resin B to be placed more uniformly on the surface of the negative electrode active material.

The dilution step is, for example, a step of diluting the kneaded material obtained in the solid-kneading step. In this embodiment, water is added to the kneaded material obtained in the solid-kneading step (here, the kneaded material with no lumps), and the kneading is then performed until the kneaded material becomes a paste. The mixing step is, for example, a step of mixing the kneaded material obtained after the dilution step and the binder. In this embodiment, an emulsion solution of a binder (e.g., an emulsion aqueous solution of the resin A) prepared at a predetermined concentration is added to the paste-like kneaded material obtained after the dilution step and mixed with this paste-like kneaded material, thereby making it possible to obtain a slurry for forming the first negative electrode active material layer.

The applying step is, for example, a step of applying the slurry for forming the first negative electrode active material layer onto the negative electrode current collector. In this embodiment, the slurry is applied onto a copper foil as the negative electrode current collector. An applying method is not particularly limited, and any conventionally known method may be adopted. The drying step is, for example, a step of drying the slurry for forming the first negative electrode active material layer applied onto the negative electrode current collector in the applying step to obtain a dried film. The conditions for drying are not particularly limited, and any condition for fabricating this kind of negative electrode is desirably adopted as appropriate. The pressing step is, for example, a step of pressing the dried film obtained in the drying step to obtain the first negative electrode active material layer. The conditions for pressing are not particularly limited, and any condition for fabricating this kind of negative electrode is desirably adopted as appropriate.

A method of forming the second negative electrode active material layer 642 is not particularly limited. For example, the negative electrode active material and the binder are dispersed in water to prepare a slurry for forming the second negative electrode active material layer. The slurry is then applied onto a surface of the first negative electrode active material layer 641 and dried. Here, by pressing, the negative electrode 60 having the negative electrode active material layer 64 provided on the surface of the negative electrode current collector 62 is fabricated; the negative electrode active material layer 64 has the first negative electrode active material layer 641 and the second negative electrode active material layer 642.

The separator 70 is, for example, a porous sheet (film) made of a resin material such as polyethylene (PE), polypropylene (PP), polyester, cellulose, or polyamide. The porous sheet may have a single-layer structure or a laminated structure of two or more layers (e.g., a three-layer structure with a PP layer stacked on both sides of a PE layer). A heat resistant layer (HRL) may be provided on a surface of the separator 70.

The case 30 is, for example, an outer container that houses therein the electrode body 20 and the non-aqueous electrolyte 80. The case 30 here is a flat, rectangular case. As shown in FIG. 1, the case 30 has a body 31 and a closing plate 32. The body 31 here houses therein the electrode body 20. In this embodiment, the body 31 has a rectangular bottom surface 31a, a pair of opposing first side surfaces 31b, a pair of opposing second side surfaces 31c, and an opening 31h. In the embodiment shown in FIG. 1, the pair of opposing first side surfaces 31b are surfaces extending from a pair of opposing long sides of the bottom surface 31a. The pair of opposing second side surfaces 31b are surfaces extending from a pair of opposing short sides of the bottom surface 31a. The opening 31h is surrounded by the pair of opposing first side surfaces 31b and the pair of opposing second side surfaces 31c and faces the bottom surface 31a.

The closing plate 32 is a member that closes, for example, the opening 31h. The closing plate 32 desirably has, for example, a shape corresponding to an outer shape of the opening 31h. In this embodiment, the closing plate 32 is fitted into the opening 31h and joined to the periphery of the opening 31h (body 31) to close the opening 31h. The body 31 and the closing plate 32 are joined together, for example, by laser welding or the like.

As shown in FIG. 1, the case 30 has a positive electrode terminal 42, a negative electrode terminal 44, a safety valve 36, and a pouring hole (not shown) at the closing plate 32. The positive electrode terminal 42 is, for example, an external connection terminal on the positive electrode side. The positive electrode terminal 42 here is electrically connected to the positive electrode 50 of the electrode body 20 via the current collector plate 42a. The negative electrode terminal 44 is, for example, an external connection terminal on the negative electrode side. The negative electrode terminal 44 here is electrically connected to the negative electrode 60 of the electrode body 20 via the current collector plate 44a. The safety valve 36 is, for example, a thin-walled section set to release internal pressure of the case 30 when the internal pressure increases to a predetermined level or higher. The pouring hole is, for example, a portion through which the non-aqueous electrolyte 80 is poured into the case 30.

The non-aqueous electrolyte 80 contains, for example, an electrolyte salt and a non-aqueous solvent. The electrolyte salt is, for example, LiPF₆. The concentration of the electrolyte salt in the non-aqueous electrolyte 80 is, for example, desirably 0.7 mol/L to 1.3 mol/L. Examples of the non-aqueous solvents desirably include carbonates such as ethylene carbonate (EC), diethyl carbonate (DEC), dimethyl carbonate (DMC), ethyl methyl carbonate (EMC), monofluoroethylene carbonate (MFEC), difluoroethylene carbonate (DFEC) monofluoromethyl difluoromethyl carbonate (F-DMC), and trifluorodimethyl carbonate (TFDMC). These can be used alone or in combination of two or more kinds.

The electricity storage device 100 can be used for various applications. Suitable applications include drive power sources mounted on vehicles, such as electric vehicles (BEVs), hybrid electric vehicles (HEVs), and plug-in hybrid electric vehicles (PHEVs). The electricity storage device 100 can be used as a storage battery, such as a compact power storage device. Plural electricity storage devices 100 may be connected in series and/or parallel to construct a battery assembly.

As described above, the electricity storage device 100 includes the negative electrode 60 having the sheet-shaped negative electrode current collector 62 and the negative electrode active material layer 64 provided on the negative electrode current collector 62. The negative electrode active material layer 64 includes the first negative electrode active material layer 641 and the second negative electrode active material layer 642. The first negative electrode active material layer 641 contains the negative electrode active material 681, the binder 682 made of the resin A, and the resin B 683 (see FIG. 4). The second negative electrode active material layer 642 contains the negative electrode active material and the binder, and the content of the resin B in the second negative electrode active material layer 642 is smaller than the content of the resin B 683 in the first negative electrode active material layer 641. The resin B 683 here is a resin having water solubility and thermoplasticity. The first negative electrode active material layer 641 is provided between the second negative electrode active material layer 642 and the negative electrode current collector 62.

By forming the negative electrode active material layer 64 having a two-layer structure of the first negative electrode active material layer 641 and the second negative electrode active material layer 642, each layer can have a mutually different function. The first negative electrode active material layer 641 contains a relatively large amount of the resin B 683 having water solubility and thermoplasticity, which can enhance the affinity between the first negative electrode active material layer 641 and water when processing the negative electrode 60. When heating the water used to process the negative electrode 60, the resin B 683 having thermoplasticity may be deformed by the heat, resulting in reduced adhesiveness of the first negative electrode active material layer 641 to the negative electrode current collector 62. Therefore, by providing the first negative electrode active material layer 641 between the negative electrode current collector 62 and the second negative electrode active material layer 642, the negative electrode active material layer 64 can be more easily separated from the negative electrode current collector 62. This enables the recovery of the negative electrode current collector with high purity, thus improving the recyclability of the electricity storage device 100. In addition to this, the content of the resin B in the second negative electrode active material layer 642 is made relativity lower, achieving a configuration in which the storage device 100 can be appropriately charged and discharged.

The technology disclosed herein discloses a method of manufacturing a recovered negative electrode current collector. The method of manufacturing a recovered negative electrode current collector disclosed herein includes, for example, removing the negative electrode 60 from the electricity storage device 100 and isolating the negative electrode current collector 62 from the negative electrode 60. As described above, in the electricity storage device 100, the negative electrode active material layer 64 is configured to be easily separated from the negative electrode current collector 62. According to the method of manufacturing a recovered negative electrode current collector disclosed herein, the negative electrode current collector with high purity can be manufactured as a raw material, thus enhancing the recyclability of the electricity storage device 100.

The manufacturing method includes, for example, an opening step, a first removal step, a second removal step, an isolation step and a drying step. The opening step is, for example, a step of opening the electricity storage device 100. In this embodiment, the electricity storage device 100 is opened by separating the closing plate 32 from the body 31 of the case 30. The separation of the closing plate 32 from the body 31 adopts any means for processing this kind of electricity storage device 100 without any particular restrictions. Prior to the opening step, the electricity storage device 100 is desirably discharged as needed. The first removal step is, for example, a step of removing the electrode body 20 from the opened electricity storage device 100. In this embodiment, the electrode body 20 is connected to the positive electrode terminal 42 and the negative electrode terminal 44, which are provided on the closing plate 32. Thus, for example, the electrode body 20 is desirably removed from the electricity storage device 100, as a combined member with the closing plate 32 after the opening step.

The second removal step is, for example, a step of removing the negative electrode 60 from the electrode body 20 removed in the first removal step. In the first removal step here, the electrode body 20 is removed as a combined member with the closing plate 32, the positive electrode terminal 42, and the negative electrode terminal 44. For example, in the second removal step, the electrode body 20 and the closing plate 32 are desirably separated from each other by removing the current collector plate 22a and the current collector plate 24a from the electrode body 20. Next, the negative electrode 60 is desirably removed from the electrode body 20 separated from the closing plate 32.

The isolation step is, for example, a step of isolating the negative electrode current collector 62 from the negative electrode 60. The negative electrode 60 here is the negative electrode 60 removed in the second removal step. In this embodiment, in the isolation step, the negative electrode current collector 62 is isolated from the negative electrode 60 by immersing the negative electrode 60 in water that is heated. The temperature of the water can be set as appropriate according to, for example, the kind, content, etc., of the resin B. The lower the temperature of the water in which the negative electrode 60 is immersed, the smaller the amount of energy required to recover the negative electrode current collector 62 can be, thereby reducing the environmental impacts. The temperature of the water is, for example, lower than or equal to the boiling point (100° C. or lower). From the above viewpoint, it is preferably 95° C. or lower, more preferably 90° C. or lower, even more preferably 85° C. or lower, and particularly preferably 80° C. or lower. The higher the temperature of the water in which the negative electrode 60 is immersed, the easier it is to separate the first negative electrode active material layer 641 from the negative electrode current collector 62, and thus the negative electrode current collector 62 with higher purity can be recovered. From this viewpoint, the temperature of the water is, for example, 50° C. or higher, preferably 55° C. or higher, and more preferably 60° C. or higher. Although not particularly limited, from the viewpoint of more efficient isolation of the negative electrode current collector 62, the water in which the negative electrode 60 is immersed may be stirred, or a container containing the negative electrode 60 and water may be shaken.

The negative electrode current collector 62 isolated in the isolation step can be used, for example, as a raw material for a recovered negative electrode current collector through washing, drying, or the like, as needed. Although not particularly limited, the isolated negative electrode current collector 62 can be used as a copper raw material, for example, in a refining process of an electrolytic copper foil. Since the isolated negative electrode current collector 62 has a higher purity, it can be used as a copper raw material to enable efficient electrolytic refining.

In the following, a description will be given of test examples related to the present disclosure, but it is not intended to limit the present disclosure to those shown in the test examples below.

### <Fabrication of Test Negative Electrode>

### Example 1

Natural graphite particles were prepared as the negative electrode active material. Styrene butadiene rubber (SBR) was prepared as the resin A. Polyethylene oxide (PEO) with a weight average molecular weight of 8 million was prepared as the resin B. First, the negative electrode active material and the resin B were weighed to have a predetermined ratio and then mixed using a planetary mixer to obtain a mixed powder. Next, water was added to the mixed powder until the mixed powder became clay-like. The mixed powder was then kneaded using the planetary mixer. The solid content of the mixed powder during the solid-kneading was generally 60%. Solid-kneading was performed until no particles that had grown to a predetermined size or larger (so-called lumps) were visually observed in the kneaded material. The kneaded material was then further kneaded while adding water thereto until it became a paste. Next, an SBR emulsion solution prepared at a predetermined concentration was added to and mixed with the paste-like mixture to obtain a slurry for forming the first negative electrode active material layer. The mass ratio of the negative electrode active material, the resin A (binder), and the resin B (negative electrode active material: resin A: resin B) in the slurry was 98:1:1.

Next, the slurry for forming the first negative electrode active material layer was applied to both surfaces of the copper foil, dried, and then subjected to a compression process using a roll press machine to form the first negative electrode active material layer on the copper foil. This was used as a test negative electrode of this Example. The applying amount (basis weight) of the slurry in the negative electrode was 10 mg/cm² per side. The density of the first negative electrode active material layer after the pressing was 1.5 g/cm³.

### Example 2

Polyethylene oxide (PEO) with a weight average molecular weight of 5 million was used as the resin B. A test negative electrode of this Example was fabricated using the same material and procedure as those of Example 1, expect for the above point.

### Example 3

Polyethylene oxide (PEO) with a weight average molecular weight of 4 million was used as the resin B. A test negative electrode of this Example was fabricated using the same material and procedure as those of Example 1, expect for the above point.

### Comparison Example

Instead of the resin B, carboxymethylcellulose (CMC) with a weight average molecular weight of 300,000 was used. A test negative electrode of this Example was fabricated using the same material and procedure as those of Example 1, expect for the above point.

### <Measurement of Carbon Residual Ratio>

The test negative electrode of each Example was stirred in warm water at 70° C. for 1 hour. The test negative electrode was then removed from the water and dried. The surface of the test negative electrode after the drying was observed using a scanning electron microscope (SEM), and observation images in five fields of view were obtained at random. The size of the observation image was set so that the image, which was a surface image of the negative electrode, covered a 1.5 cm×1.5 cm field of view. The observation images obtained were binarized using “ImageJ”, which was an image analysis software, and an area proportion of black parts in the observation image was calculated. The arithmetic mean value of the area proportions of the black parts calculated for the five observation images was obtained and defined as the carbon residual ratio (%) in the test negative electrode. The results are shown in a corresponding column of Table 1.

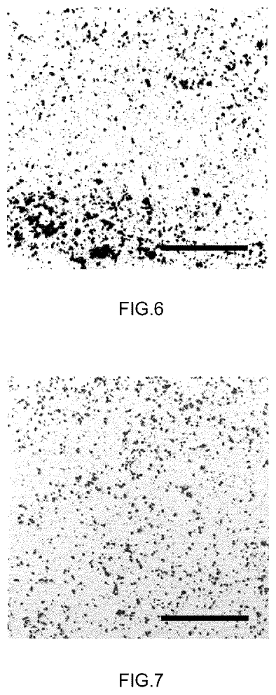

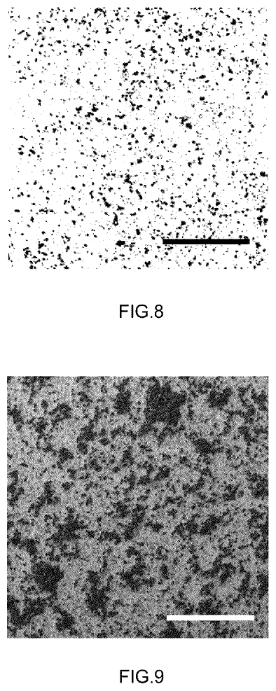

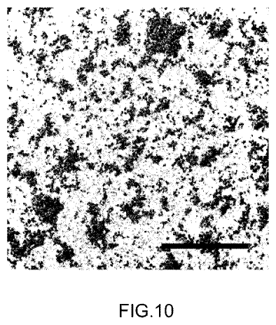

FIGS. 5 to 10 each show an SEM observation image or a binarized image obtained by a binarization process. FIG. 5 shows an SEM observation image of Example 1. FIG. 6 shows a binarized image of Example 1. FIG. 7 shows an SEM observation image of Example 2. FIG. 8 shows a binarized image of Example 2. FIG. 9 shows an SEM observation image of Comparative Example 1. FIG. 10 shows a binarized image of Comparative Example 1. All the images shown in FIGS. 5 to 10 correspond to an observation field of view of 1.5 cm in length and 1.5 cm in width. The scale bar indicates 5 mm. In FIGS. 6, 8, and 10, the black parts represent parts where carbon remains, as described above.

TABLE 1

| | | Weight average | Carbon Residual |
|---|---|---|---|
| | Resin | molecular weight | Ratio (%) |
| Example 1 | PEO | 8 million | 12 |
| Example 2 | PEO | 5 million | 8 |
| Example 3 | PEO | 4 million | 7 |
| Comparative Example | CMC | 300,000 | 35 |

As shown in Table 1, the carbon residual ratio in each of Examples 1 to 3 was lower than that in Comparative Example. The test negative electrodes of Examples 1 to 3 included the first negative electrode active material layer containing the resin B (here, polyethylene oxide (PEO)), which had water solubility and thermoplasticity. From the results of this test examples, it was found that the negative electrode active material layer could be easily separated from the negative electrode current collector in the negative electrode, wherein the negative electrode was configured to have the negative electrode active material layer including the first negative electrode active material layer and the second negative electrode active material layer, with the first negative electrode active material layer being provided between the negative electrode current collector and the second negative electrode active material layer, the first negative electrode active material layer containing the resin B, which had water solubility and thermoplasticity. It was also found that by using the electricity storage device having such a negative electrode, the recovered negative electrode current collector with higher purity could be manufactured.

As described above, the specific aspects of the technology disclosed herein are those described in the following respective items.

Item 1: An electricity storage device comprising: a negative electrode including a sheet-shaped negative electrode current collector and a negative electrode active material layer provided on the negative electrode current collector,
wherein
the negative electrode active material layer including:
a first negative electrode active material layer containing a negative electrode active material, a binder made of a resin A, and a resin B; and
a second negative electrode active material layer containing the negative electrode active material and the binder,
a content of the resin B in the second negative electrode active material layer is smaller than a content of the resin B in the first negative electrode active material layer,
the resin B is a resin having water solubility and thermoplasticity, and
the first negative electrode active material layer is provided between the second negative electrode active material layer and the negative electrode current collector.
   Item 2: The electricity storage device according to Item 1, wherein the content of the resin B in the second negative electrode active material layer is ¼ or less of the content of the resin B in the first negative electrode active material layer.
   Item 3: The electricity storage device according to Item 1 or 2, wherein the resin B has a softening point of 80° or lower.
   Item 4: The electricity storage device according to any one of Items 1 to 3, whether the resin B is polyethylene oxide.
   Item 5: The electricity storage device according to any one of Items 1 to 4, whether the resin B has a weight average molecular weight of 100,000 to 10 million.
   Item 6: The electricity storage device according to any one of Items 1 to 5, whether the resin A is a styrene butadiene rubber.
   Item 7: A method for manufacturing a recovered negative electrode current collector, comprising: removing the negative electrode from the electricity storage device according to any one of Items 1 to 6; and isolating the negative electrode current collector from the negative electrode.
   Item 8: The method according to Item 7, wherein the negative electrode current collector is isolated from the negative electrode by immersing the negative electrode in water at 80° C. or lower.

Although the embodiments of the technology described herein have been described above, the technology described herein are not intended to be limited to the above embodiments. The technology disclosed herein may also be implemented in other embodiments. The technology described in claims includes various variations and modifications of the embodiments illustrated above. For example, some of the above embodiments can be substituted with other variants, and other variants can also be added to the above embodiments. A technical feature can also be deleted as appropriate if the feature is not described as essential.

What is claimed is:

1. An electricity storage device comprising: a negative electrode including a sheet-shaped negative electrode current collector and a negative electrode active material layer provided on the negative electrode current collector,
wherein
the negative electrode active material layer including:
a first negative electrode active material layer containing a negative electrode active material, a binder made of a resin A, and a resin B; and
a second negative electrode active material layer containing the negative electrode active material and the binder,
a content of the resin B in the second negative electrode active material layer is smaller than a content of the resin B in the first negative electrode active material layer,
the resin B is a resin having water solubility and thermoplasticity, and
the first negative electrode active material layer is provided between the second negative electrode active material layer and the negative electrode current collector.

2. The electricity storage device according to claim 1, wherein the content of the resin B in the second negative electrode active material layer is ¼ or less of the content of the resin B in the first negative electrode active material layer.

3. The electricity storage device according to claim 1, wherein the resin B has a softening point of 80° or lower.

4. The electricity storage device according to claim 1, whether the resin B is polyethylene oxide.

5. The electricity storage device according to claim 4, whether the resin B has a weight average molecular weight of 100,000 to 10 million.

6. The electricity storage device according to claim 1, whether the resin A is a styrene butadiene rubber.

7. A method for manufacturing a recovered negative electrode current collector, comprising: removing the negative electrode from the electricity storage device according to claim 1; and isolating the negative electrode current collector from the negative electrode.

8. The method according to claim 7, wherein the negative electrode current collector is isolated from the negative electrode by immersing the negative electrode in water at 80° C. or lower.
